(19) United States
(12) Patent Application Publication
(10) Pub. No.: US 2012/0163219 A1
(43) Pub. Date: Jun. 28, 2012

(54) METHOD AND APPARATUS FOR SUPPORTING MOBILITY BASED ON FLOW IN PMIPv6

(75) Inventors: Sung Kuen LEE, Anyang-si (KR); Kyoung Hee LEE, Seongnam-si (KR); Kyeong Seob CHO, Daejeon (KR); Eun Jun RHEE, Daejeon (KR); II Gu JUNG, Daejeon (KR); Seng Kyoun JO, Chungbuk (KR); Hyun Woo LEE, Daejeon (KR); Won RYU, Daejeon (KR)

(73) Assignee: Electronics and Telecommunications Research Institute, Daejeon (KR)

(21) Appl. No.: 13/335,131

(22) Filed: Dec. 22, 2011

(30) Foreign Application Priority Data
Dec. 23, 2010 (KR) 10-2010--0133376

(51) Int. Cl. H04W 8/00; H04W 24/00

(52) U.S. Cl. 370/252; 370/328

(57) ABSTRACT

A method and apparatus for supporting a flow-based mobility to a multi-mode terminal equipped with a plurality of wired and wireless network interfaces, and selecting an access network may be provided in the PMIPv6 technology that supports a network-based mobility. Also, a flow-based location registration process and a handover process of the multi-mode terminal may be provided, and a flow-based data transmission process and an access network selecting process for the multi-mode terminal may be provided.

### CROSS-REFERENCE TO RELATED APPLICATION

This application claims the benefit of Korean Patent Application No. 10-2010-0133376, filed on Dec. 23, 2010, in the Korean Intellectual Property Office, the disclosure of which is incorporated herein by reference.

### BACKGROUND

1. Field of the Invention

The present invention relates to a method and apparatus for supporting a flow-based mobility in the Proxy Mobile IP version 6 (PMIPv6), and more particularly, to a method for supporting a flow-based mobility of a multi-mode terminal equipped with a plurality of wired or wireless network interfaces, and for selecting an access network.

2. Description of the Related Art

A ubiquitous mobile network service should provide an optimal quality of service (QoS) to users at every time and place, under various wired and wireless access technologies.

For the ubiquitous mobile networking service, a technology that provides mobility to users continuously by unifying and integrating the wired and wireless access technologies may be required.

Accordingly, varied studies and standardization associated with management of host-based IP mobility have been conducted, for example, Mobile IP (MIP).

The MIP is a technology standardized by efforts of many researchers over a long period of time.

However, the MIP is not actively introduced to a common network due to a few drawbacks. For example, most of operating systems currently does not support the MIP and the protocol stack is too heavy to be equipped in a small terminal. Also, an overhead may be created in that terminals are required to exchange binding management messages by themselves.

Accordingly, to overcome the drawbacks of the MIP, the Internet Engineering Task Force (IETF) network-based localized mobility management (NetLMM) working group has conducted research and standardization for management of a network-based IP mobility based on the PMIPv6.

To provide mobility to users continuously over various wired and wireless access networks, a multi-mode terminal including a plurality of wired and wireless interfaces may be required basically.

Accordingly, the existing networking technologies considered, conventionally, in a single-mode terminal including a single network interface may need to be extended and improved.

Particularly, there may be a desire for a scheme of supporting the flow-based mobility when the multi-mode terminals are widely used in those various wired and wireless networks.

The scheme of supporting the flow-based mobility may be a per-service mobility supporting scheme that delivers, based on a characteristic of a service or a flow, a service associated with a predetermined flow through an optimal access network environment preferred by a subscriber.

The NetExt working group in IETF has conducted research and standardization for supporting a network-based flow mobility based on the PMIPv6 architecture. However, the PMIPv6-based flow mobility frameworks of the NetExt working group may have a drawback in that they do not currently specify the methods for sensing a state and an intention of a network access of the multi-mode terminal. Accordingly, it is difficult to properly provide a flow-based mobility for the multi-mode terminal.

Also, a mechanism for selecting an access network based on a characteristic of each flow is non-existent for the multi-mode terminal.

Therefore, there is a desire for a new flow mobility supporting scheme based on PMIPv6 and a specific access network selection scheme that a combination of those schemes may provide an optimal communication environment to a multi-mode terminal based on a characteristic of a flow of the multi-mode terminal in a wired and wireless integrated access network environment.

### SUMMARY

An aspect of the present invention provides a method of supporting a flow-based mobility to a multi-mode terminal including a plurality of wired and wireless network interfaces.

Another aspect of the present invention also provides a method in which a multi-mode terminal including a plurality of wired and wireless network interfaces selects an access network.

According to an aspect of the present invention, there is provided a method of supporting a flow mobility based on the proxy mobile internet protocol version 6 (PMIPv6), the method including receiving, by a first mobile access gateway (MAG) from a multi-mode terminal, first flow information associated with a first flow, registering, by the first MAG, the first flow information associated with the first flow, transmitting, by the first MAG to the multi-mode terminal, data of the first flow, and the multi-mode terminal is equipped with a plurality of physical network interfaces, and the first MAG is connected to the multi-mode terminal through a first physical network interface among the plurality of physical network interfaces of the multi-mode terminal.

The registering may include generating, by the first MAG, flow-based binding information based on the first flow information so as to add the first flow information to a binding entry of the first MAG.

The registering may include transmitting, by the first MAG, a location registration message including the first flow information to a local mobility anchor (LMA), and receiving, by the first MAG from the LMA, a response message in response to the location registration message.

The registering may further include updating, by the LMA, a flow-based binding entry for the multi-mode terminal, based on the first flow information.

The registering may further include updating, by the first MAG, flow-based binding information, based on the response message.

The first flow information may include first multi-mode terminal identification (ID) information that distinguishes the first multi-mode terminal from a different terminal.

The first flow information may include a first flow ID of the first flow and characteristic information of the first flow.

The characteristic information of the first flow may include configuration information of the first flow and a quality of service (QoS) of the first flow.

The first flow information may include information associated with an interface to be used as a default among the plurality of physical network interfaces of the multi-mode terminal.

The method may further include receiving, by a second MAG from the multi-mode terminal, second flow information associated with a second flow, registering, by the second MAG, the second flow information associated with the second flow, and transmitting, by the second MAG data of the second flow to the multi-mode terminal, and the second MAG may be connected to the multi-mode terminal through a second physical network interface among the plurality of physical network interfaces of the multi-mode terminal.

The method may further include transmitting, by the second MAG, the data of the first flow to the multi-mode terminal.

The method may further include receiving, by the LMA, data from a correspondent node, searching, by the LMA, for flow-based binding information associated with a second flow to which the data belongs, and determining an access network for the second flow based on a result of the search, transmitting, by the LMA, the data to a second MAG corresponding to the access network, and transmitting, by the second MAG, the data to the multi-mode terminal.

The LMA may search for the flow-based binding information associated with the second flow to which the data belongs, and may utilize the flow-based binding information included in a binding entry associated with the second flow to which the data belongs when the binding entry exists, so as to determine the access network.

The data may be transmitted from the LMA to the second MAG through an IP-in-IP tunneling.

The LMA may search for the flow-based binding information associated with the second flow to which the data belongs, and, when a binding entry associated with the second flow to which the data belongs fails to exit, may utilize policy information of the multi-mode terminal and the second flow information of the data so as to define the second flow to which the data belongs, and to determine the access network to service the second flow.

The LMA may search for the flow-based binding information associated with the second flow to which the data belongs, and, when a binding entry associated with the second flow to which the data belongs fails to exist, may utilize default interface information of the multi-mode terminal so as to determine a default access network of the multi-mode terminal to be the access network.

According to another aspect of the present invention, there is provided a communication method of a multi-mode terminal, equipped with a plurality of physical interfaces, based on a PMIPv6-based network, the method including triggering flow-based location registration by transmitting first flow information associated with a first flow forming a first service to a first mobile access gateway (MAG), and receiving data of the first flow from the first MAG, and the first MAG is connected to the multi-mode terminal through a first physical network interface among the plurality of physical network interfaces.

The method may further include triggering flow-based location registration by transmitting second flow information associated with a second flow forming a second service to a second MAG, and receiving data of the second flow from the second MAG, and the second MAG may be connected to the multi-mode terminal through a second physical network interface among the plurality of physical network interfaces.

The method may further include receiving the data of the first flow from the second MAG, monitoring the first flow, and assess a suitability of an access network that services the first flow, and searching for and determining an access network to service the first flow based on the assessment, and the first MAG exists in the access network determined newly by the search.

According to still another aspect of the present invention, there is provided a multi-mode terminal equipped with a plurality of physical network interfaces, the multi-mode terminal including a controller to generate first flow information associated with a first flow forming a first service and second flow information associated with a second flow forming a second service, a first physical network interface to transmit the first flow information to a first mobile access gateway (MAG), and a second physical network interface to transmit the second flow information to a second MAG.

Additional aspects, features, and/or advantages of the invention will be set forth in part in the description which follows and, in part, will be apparent from the description, or may be learned by practice of the invention.

### Effect

Exemplary embodiments may provide a method of supporting a flow-based mobility to a multi-mode terminal equipped with a plurality of wired and wireless network interfaces.

Exemplary embodiments may provide a method in which a multi-mode terminal equipped with a plurality of wired and wireless network interface selects an access network.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a proxy mobile internet protocol version 6 (PMIPv6) network according to an embodiment of the present invention;

FIG. 2 is a flowchart illustrating a flow-based location registration for a multi-mode terminal in a PMIPv6-based network according to an embodiment of the present invention;

FIG. 3 is a flowchart illustrating a flow-based handover for a multi-mode terminal in a PMIPv6-based network according to an embodiment of the present invention;

FIG. 4 is a flowchart illustrating a flow-based data transmission and an access network selection for a multi-mode terminal in a PMIPv6-based network according to an embodiment of the present invention; and

FIG. 5 is a diagram illustrating a configuration of a multi-mode terminal according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

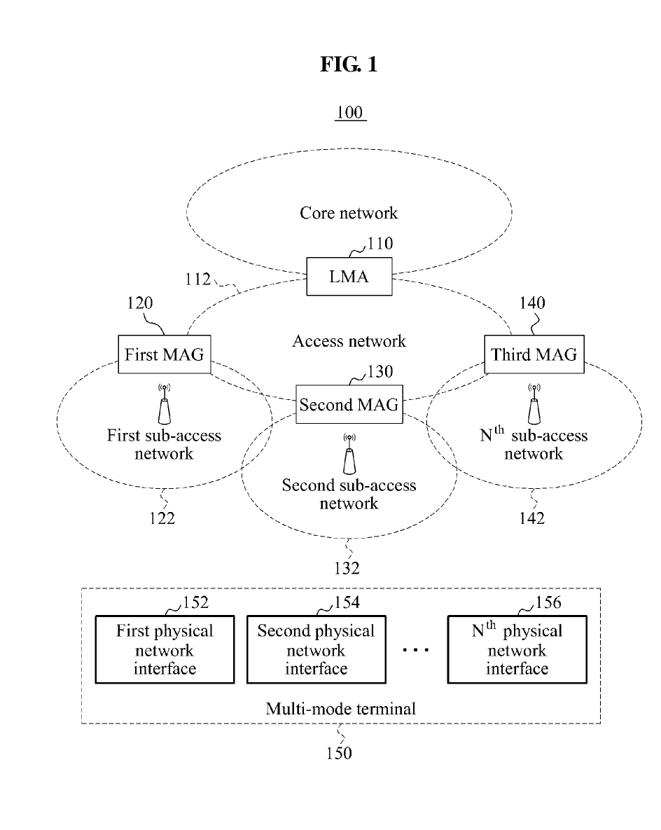

FIG. 1 illustrates a configuration of a proxy mobile internet protocol version 6 (PMIPv6) network according to an embodiment of the present invention.

The PMIPv6 is a network-based mobility management scheme.

A PMIPv6 domain 100 may include a local mobility anchor (LMA) 110. Further, the PMIPv6 domain 100 may include mobility supporting nodes 120, 130, and 140. Here, the mobility supporting node may also be referred to as a mobile access gateway (MAG).

The LMA 110 may function as a home agent (HA) for a mobile terminal 150 in the PMIPv6 domain 100.

The LMA 110 may exist in a location of a gateway of the PMIPv6 domain 100. The LMA 110 may allocate a home network prefix (HNP) to the mobile terminal 150, and may manage addresses and location information associated with all mobile terminals 150 in the PMIPv6 domain 100.

The LMA 100, that is, the gateway of the PMIPv6 domain 100, may receive all packets transmitted from an external side of the PMIPv6 domain 100 to the mobile terminals 150 in the PMIPv6 domain 100. In this instance, the received packets may be transferred to the mobile terminals 150 through an internet protocol-in-internet protocol (IP-in-IP) tunneling with an MAG, for example, a first MAG 120, a second MAG 130 or a third MAG 140.

Also, packets transmitted from an inside of the PMIPv6 domain 100 to an external side of the PMIPv6 domain 100 may be transferred to the LMA 110 through the tunneling with the MAG, for example, the MAG 120, 130, or 140, and may be transferred from the LMA 110 to the external side of the PMIPv6 domain 100.

The MAG may exist in a location of an access router. The MAG may be a first hop accessed by the terminal 150 directly.

Therefore, the MAG may monitor a network access that is, connecting and releasing, of the mobile terminal 150 in an access link. Also, the MAG may perform, on behalf of the mobile terminal 150, a mobility supporting signaling with respect to the LMA 110 and a mobile node (MN).

When the mobile terminal 150 accesses an access router, on behalf of the mobile terminal 150, the MAG may set a connection between the LMA 110 and the mobile terminal 150, and may receive a packet transferred from the LMA 110 so as to transfer the received packet to the mobile terminal 150.

An access network 112, managed by the LMA 110, may be configured to include sub-access networks 122, 132, and 142 in which all MAGs 120, 130, and 140 support the same wireless technology. Also, the access network 112 may be configured to include sub-access networks 122, 132, and 142 in which the all MAGs 120, 130, and 140 each support a different wireless technology from one another.

The mobile terminal 150 may be a multi-mode terminal equipped with a plurality of physical network interfaces 152, 154, and 156.

Hereinafter, the mobile terminal 150 may be referred to as a multi-mode terminal 150.

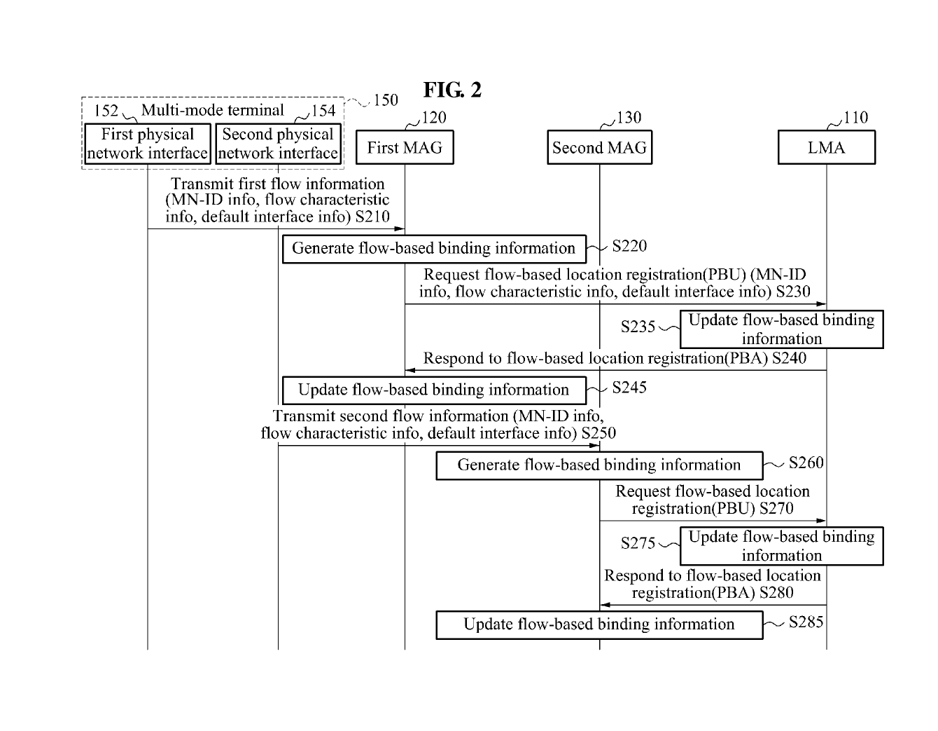

FIG. 2 illustrates a flow-based location registration for the multi-mode terminal 150 in a PMIPv6-based network according to an embodiment of the present invention.

As an example, when the multi-mode terminal 150 starts a new service, the multi-mode terminal 150 may desire to receive a new service through a predetermined interface or a predetermined network. In this example, the multi-mode terminal 150 may provide information associated with a predetermined flow or predetermined flows forming the new service to MAGs included in a network, for example, the MAGs 120 and 130, so as to trigger the flow-based location registration.

Here, a flow may refer to successive IP packets that have the same characteristic and form a predetermined service.

The multi-mode terminal 150 may include a plurality of physical network interfaces, that is, N physical network interfaces. Referring to FIG. 2, there may be provided the flow-based location registration for the multi-mode terminal 150 equipped with two physical network interfaces, that is, a first physical network interface 152 and a second physical network interface 154.

The multi-mode terminal 150 may desire to receive a first service associated with a first flow, through the first physical network interface 152, and may desire to receive a second service associated with a second flow, through the second physical network interface 154.

In operations S210 through S245, a process for the first flow may be performed.

In operation S210, the multi-mode terminal 150 may transmit, to the first MAG 120, first flow information associated with the first flow forming the first service. The multi-mode terminal 150 may trigger a flow-based location registration by transmitting the first flow information to the first MAG 120.

That is, the first MAG 120 may receive the first flow information associated with the first flow, from the multi-mode terminal 150.

The first MAG 120 may be an MAG accessed by the first physical network interface 152 in the network. That is, the first MAG 120 may be connected to the multi-mode terminal 150 through the first physical network interface 152.

The first flow information or another piece of flow information which will be described later, may include mobile node identification (MN-ID) information of the multi-mode terminal 150, a flow identification (F-ID) of the first flow, flow characteristic information of the first flow, and information associated with a default interface of the multi-mode terminal 150. Also, the MN-ID information of the multi-mode terminal 150, the F-ID of the first flow, the flow characteristic information of the first flow, the information associated with the default interface of the multi-mode terminal 150 may be provided to the network by the multi-mode terminal 150.

The first multi-mode terminal 150 may be distinguished from another terminal based on the MN-ID information.

The F-ID may be an ID of each flow to be serviced through the network.

The flow characteristic information may be information associated with a characteristic of a flow, and may include flow configuration information and quality of service (QoS) of the flow.

The default interface may be an interface to be used as a default among the plurality of physical network interfaces of the multi-mode terminal 150. When the multi-mode terminal 150 does not select a predetermined physical network interface for a predetermined flow, the predetermined flow may be transmitted and received through the default interface.

In operations S220 through S245, the first MAG 120 may register the first flow information associated with the first flow.

In operation S220, the first MAG 120 may generate flow-based binding information based on the first flow information so as to add the first flow information to a corresponding binding entry.

In operation S230, the first MAG 120 may transmit, to the LMA 110, a location registration message including the first flow information. The location registration message may be a proxy binding update (PBU) message.

The first MAG 120 may request registering of a flow-based location from the LMA 110 by transmitting the location registration message.

In operation S235, the LMA 110 may add or update the flow-based binding entry for the multi-mode terminal 150, based on the first flow information.

In operation S240, the LMA 110 may transmit, to the first MAG 120 in response to the addition or the update, a response message. That is, the first MAG 120 may receive, from the LMA 110, in response to the location registration message, the response message. In this instance, the response message may be a proxy binding acknowledge (PBA) message.

In operation S245, the first MAG 120 may update the flow-based binding information associated with the first flow information, based on the response message.

Subsequently, in operations S250 through S285, a process for a second flow may be performed.

In operation S250, the multi-mode terminal 150 may transmit, to the second MAG 130, second flow information associated with a second flow forming a second service. The multi-mode terminal 150 may trigger a flow-based location registration by transmitting the second flow information to the second MAG 130.

That is, the second MAG 130 may receive the second flow information associated with the second flow, from the multi-mode terminal 150.

The second MAG 130 may be an MAG accessed by the second physical network interface 154 in the network. That is, the second MAG 130 may be connected to the multi-mode terminal 150 through the second physical network interface 154.

The second flow information or another piece of flow information which will be described later, may include MN-ID information of the multi-mode terminal 150, an F-ID of the second flow, flow characteristic information of the second flow, and information associated with a default interface of the multi-mode terminal 150. Also, the MN-ID information of the multi-mode terminal 150, the F-ID of the second flow, the flow characteristic information of the second flow, the information associated with the default interface of the multi-mode terminal 150 may be provided to the network by the multi-mode terminal 150.

In operations S280 through S285, the second MAG 130 may register the second flow information associated with the second flow.

In operation S250, the second MAG 130 may generate flow-based binding information based on the second flow information so as to add the second flow information to a corresponding binding entry.

In operation S260, the second MAG 130 may transmit, to the LMA 110, a location registration message including the second flow information. Here, the location registration message may be a PBU message.

The second MAG 130 may request registering a flow-based location from the LMA 110 by transmitting the location registration message.

In operation S275, the LMA 110 may add or update the flow-based binding entry for the multi-mode terminal 150, based on the second flow information.

In operation S280, the LMA 110 may transmit, to the second MAG 130 in response to the addition or the update, a response message. That is, the second MAG 130 may receive, from the LMA 110 in response to the location registration message, the response message. In this instance, the response message may be a PBA message.

In operation S285, the second MAG 130 may update the flow-based binding information associated with the second flow information, based on the response message.

Upon completion of the flow-based location registration as described in the foregoing, the first flow may be serviced through the first physical network interface 152 of the multi-mode terminal 150 and the network 122 of the first MAG 120 accessed by the first physical network interface 152. The second flow may be serviced through the second physical network interface 154 of the multi-mode terminal 150 and the network 132 of the second MAG 130 accessed by the second physical network interface 154.

Subsequently, the first MAG 120 may transmit data of the first flow to the multi-mode terminal 150. That is, the multi-mode terminal 150 may receive the data of the first flow from the first MAG 120.

Also, the second MAG 130 may transmit data of the second flow to the multi-mode terminal 150. The multi-mode terminal 150 may receive the data of the second flow from the second MAG 130.

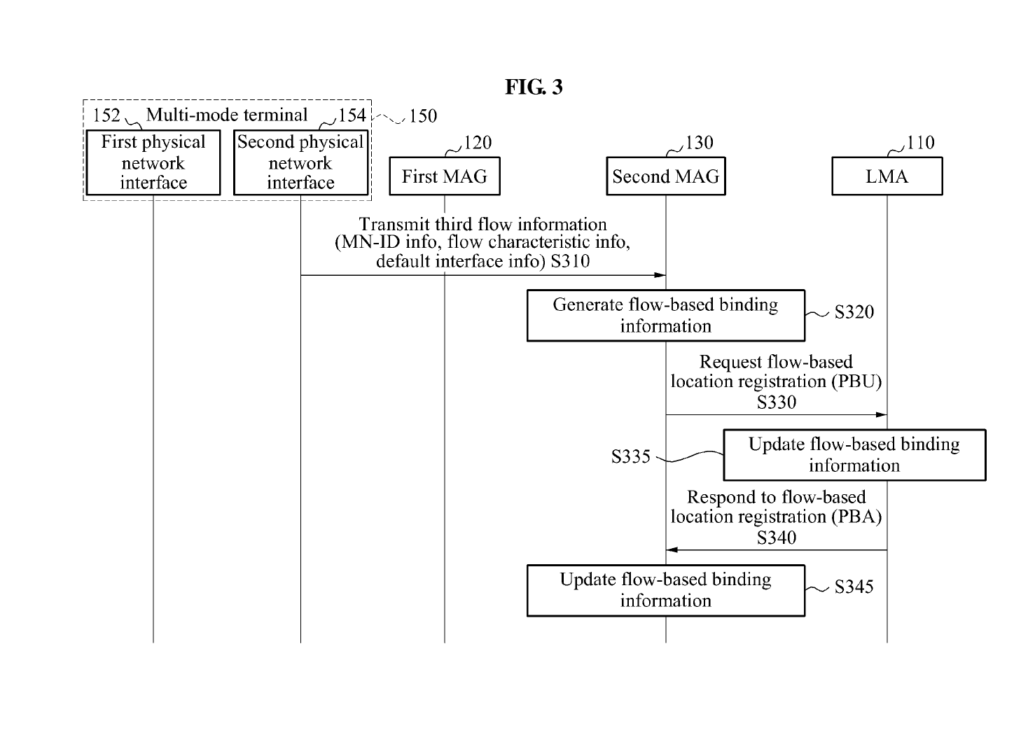

FIG. 3 illustrates a flow-based handover for the multi-mode terminal 150 in a PMIPv6-based network according to an embodiment of the present invention.

The multi-mode terminal 150 may desire to receive a service associated with a predetermined flow, through a predetermined physical network interface or through a predetermined network. In this example, the multi-mode terminal 150 may provide information associated with the predetermined flow to a network accessed by the predetermined interface, so as to trigger the flow-based handover.

Referring to FIG. 3, the multi-mode terminal 150 equipped with N physical network interfaces 152, 154, and 156 may perform a flow-based handover with respect to two physical interfaces 152 and 154.

The multi-mode terminal 150 receives a service associated with a third flow currently through the network 122 of the first MAG 120 accessed by the first physical network interface 152. In this example, an operation performed when the multi-mode terminal 150 desires to receive the service associated with the third flow through the network 154 of the second MAG 130 accessed by the second physical network interface 154 will be described.

In operation S310, the multi-mode terminal 150 may transmit, to the second MAG 130, third flow information associated with the third flow forming a third service. The multi-mode terminal 150 may transmit the third flow information to the second MAG 130, so as to trigger a flow-based handover.

That is, the second MAG 130 may receive, from the multi-mode terminal 150, the third flow information associated with the third flow.

The second MAG 130 may be an MAG included in a network accessed by the second physical network interface 154. That is, the second MAG 130 may be connected to the multi-mode terminal 150 through the second physical network interface 154.

The third flow information may include MN-ID information of the multi-mode terminal 150, an F-ID of the third flow, flow characteristic information of the third flow, and information associated with default interface of the multi-mode terminal 150. Also, the MN-ID information of the multi-mode terminal 150, the F-ID of the third flow, the flow characteristic information of the third flow, and the information associated with the default interface of the multi-mode terminal 150 may be provided to the network by the multi-mode terminal 150.

In operations S320 through S345, the second MAG 130 may register third flow information associated with the third flow.

In operation S320, the second MAG 130 may generate flow-based binding information based on the third flow information, so as to add the third flow information in a corresponding binding entry.

In operation S330, the second MAG 130 may transmit, to the LMA 110, a location registration message including the third flow information. Here, the location registration message may be a PBU message.

The third MAG 130 may request registration of a flow-based location from the LMA 110 by transmitting the location registration message.

In operation S335, the LMA 110 may add or update a flow-based binding entry for the multi-mode terminal 150, based on the third flow information.

In operation S340, the LMA 110 may transmit, to the second MAG 130, a response message in response to the addition or update. That is, the second MAG 130 may receive the response message from the LMA 110 in response to the location registration message. In this instance, the response message may be a PBA message.

In operation S345, the second MAG 130 may update the flow-based binding information associated with the third flow information, based on the response message.

After the flow-based location registration in operations S310 through S345, the third flow may be serviced to the multi-mode terminal 150 through the network 132 of the second MAG 130 accessed by the second physical network interface 154.

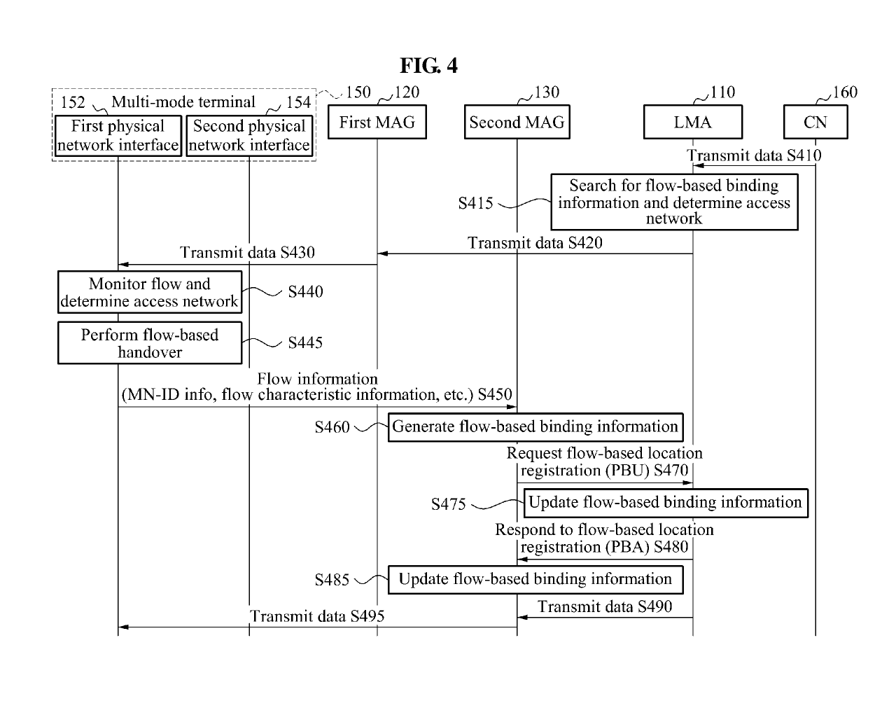

FIG. 4 illustrates a flow-based data transmission and an access network selection for the multi-mode terminal 150 in a PMIPv6-based network according to an embodiment of the present invention.

The correspondent node (CN) 160 may be a terminal to perform communication with the multi-mode terminal 150. That is, the CN 160 may transmit data to the multi-mode terminal 150.

In operation S410, the LMA 110 may receive data from the CN 160.

In operation S415, the LMA 110 that receives the data may search for flow-based binding information associated with a fourth flow to which the received data belongs, and may determine an access network for the fourth flow, based on a result of the search.

The LMA 110 may determine whether a binding entry associated with the fourth flow to which the data belongs exists in a binding table.

When the binding entry associated with the fourth flow to which the received data belongs exists, the LMA 110 may utilize the flow-based binding information included in the binding entry so as to determine an access network to which the received data is to be transmitted.

When the binding entry associated with the fourth flow to which the received data belongs fails to exist in the binding table, one of operation 1 and operation 2, described below, may be performed based on an operation mode of the LMA 110.

According to operation 1, when the LMA 110 performs an access network selection for a terminal, the LMA 110 may utilize policy information of the multi-mode terminal 150, the fourth flow information of the received data, and the like, may define the fourth flow to which the received data belongs, and may determine an access network to be used for servicing the fourth flow. The LMA 110 may generate the binding entry associated with the fourth flow.

According to operation 2, when the LMA 110 does not perform an access network selection for a terminal, the LMA 110 may utilize default interface information of the multi-mode terminal 150, so as to determine a default access network of the multi-mode terminal 150 as an access network for the received data. Here, the default access network may be a network corresponding to a default interface.

In operation S420, the LMA 110 may transmit the received data to an MAG corresponding to the determined access network, that is, the first MAG 120, through the determined access network. The LMA 110 may transfer the received data to the first MAG 120 through an IP-in-IP tunneling.

As described in the foregoing, the determined access network may be a network corresponding to a flow to which the data received by the LMA 110 belongs or the default access network of the multi-mode terminal 150.

In operation S430, the first MAG 120 may transmit the received data to the multi-mode terminal 150 to the network 122.

Subsequently, another data transmitted from the CN 160 may be transferred to the multi-mode terminal 150 through the LMA 110 and the first MAG 120.

In operation S440, the multi-mode terminal 150 that receives the data may perform monitoring with respect to a third flow to which the received data belongs, so as to assess a suitability of an access network that services the third flow.

The multi-mode terminal 150 may perform monitoring with respect to the third flow to which the received data belongs. The multi-mode terminal 150 may assess a suitability of the access network 122 that services the third flow, for the third flow. That is, the multi-mode terminal 150 may assess whether the access network 122 of the third flow is suitable for a characteristic of the third flow.

When the multi-mode terminal 150 decides that the access network 122 that services the third flow is suitable, the third flow may be serviced to the multi-mode terminal 150 continuously through the current access network 122. Accordingly, the flow-based data transmission and the access network selection may be completed.

When the multi-mode terminal 150 decides that the access network 122 that services the third flow is unsuitable, the multi-mode terminal 150 may search for a new suitable access network to service the third flow, and determine the new suitable access network.

When the multi-mode terminal 150 determines the new access network, operations S445 through S495 will be performed.

In operation S445, the multi-mode terminal 150 may start a handover to access the determined new access network 132.

The multi-mode terminal 150 may access a physical network interface, for example, the second physical network interface 154, to the new access network 132, so as to access the new access network 132.

The second MAG 130 may exist in the new access network 132.

In operation S450, the multi-mode terminal 150 may transmit, to the second MAG 130, the third flow information associated with the third flow. The multi-mode terminal 150 may transmit the third flow information to the second MAG 130, so as to trigger a flow-based handover.

That is, the second MAG 130 may receive the third flow information associated with the third flow, from the multi-mode terminal 150.

The third flow information may include MN-ID information of the multi-mode terminal 150, an F-ID of the third flow, flow characteristic information of the third flow, and information associated with a default interface of the multi-mode terminal 150.

In operations S450 through S485, the second MAG 130 may register third flow information associated with the third flow.

In operation S450, the second MAG 130 may generate flow-based binding information based on the third flow information, so as to add the third flow information to a corresponding binding entry.

In operation S460, the second MAG 130 may transmit a location registration message including the third flow information to the LAM 110. The location registration message may be a PBU message.

The second MAG 130 may transmit the location registration message, so as to request registering of a flow-based location from the LMA 110.

In operation S475, the LMA 110 may add or update the flow-based binding entry for the multi-mode terminal 150, based on the third flow information.

The binding entry in the LMA 110 may include a decision-maker (DM) field.

The DM field may indicate a subject that determines an access network for each flow. That is, the DM field may indicate which one of the LMA 110 and the multi-mode terminal 150 determines an access network for a predetermined flow.

In operation S480, the LMA 110 may transmit a response message to the second MAG 130 in response to the addition or the update. That is, the second MAG 130 may receive a response message from the LAM 110 in response to the location registration message. Here, the response message may be a PBA message.

In operation S485, the second MAG 130 may update flow-based binding information associated with the third flow information, based on the response message.

After the flow-based location registration in operations S450 through S485, the third flow may be serviced to the multi-mode terminal 150 through the network 132 accessed by the new physical network interface 154.

In operation S490, the LMA 110 may transmit new data of the third flow to the second MAG 130.

In operation S495, the second MAG 130 may transmit the new data of the third flow to the multi-mode terminal 150.

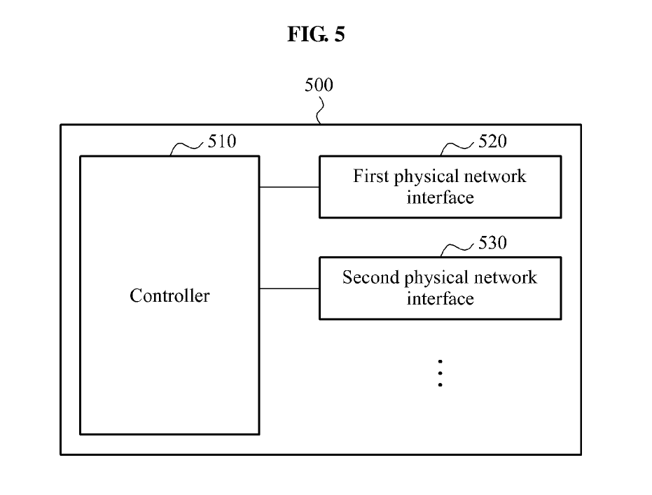

FIG. 5 illustrates a configuration of a multi-mode terminal 500 according to an embodiment of the present invention.

The multi-mode terminal 500 may include a controller 510.

The multi-mode terminal 500 may include a plurality of physical network access interfaces.

Referring to FIG. 5, a first physical network interface 520 and a second physical network interface 530 are illustrated among the plurality of physical network access interfaces.

The controller 510 may generate flow information.

The controller 510 may monitor a flow, may assess a suitability of a predetermined access network that services a predetermined flow, may search for an access network to service the predetermined flow, and may determine the access network.

The controller 510 may perform processes required for a flow-based handover.

The first physical network interface 520 may be connected to a predetermined network, for example, the network 122 of the first MAG 120.

The first physical network interface 520 may transmit a message, for example, the flow information, to an MAG included in the connected network.

Also, the first physical network interface may receive data from the connected network.

The second physical network interface 530 may be connected to a predetermined network, for example the network 132 of the second MAG 130.

The second physical network interface 530 may transmit a message, for example, flow information, to an MAG in the connected network.

The second physical network interface 530 may receive data from the connected network.

Exemplary embodiments described with reference to FIGS. 1 through 4 are applicable to the present exemplary embodiment and thus, detailed descriptions thereof will be omitted for conciseness.

According to exemplary embodiments, there may be provided a method of supporting a flow-based mobility to a multi-mode terminal equipped with a plurality of wired and wireless network interfaces and an access network selecting method, in the PMIPv6 technology that supports a network-based mobility under wired and wireless integrated access network environment.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of supporting a flow mobility based on the proxy mobile internet protocol version 6 (PMIPv6), the method comprising:
receiving, by a first mobile access gateway (MAG) from a multi-mode terminal, first flow information associated with a first flow;
registering, by the first MAG, the first flow information associated with the first flow;
transmitting, by the first MAG to the multi-mode terminal, data of the first flow,
wherein the multi-mode terminal is equipped with a plurality of physical network interfaces, and the first MAG is connected to the multi-mode terminal through a first physical network interface among the plurality of physical network interfaces of the multi-mode terminal.

2. The method of claim 1, wherein the registering comprises:
generating, by the first MAG, flow-based binding information based on the first flow information so as to add the first flow information to a binding entry of the first MAG

3. The method of claim 1, wherein the registering comprises:
transmitting, by the first MAG, a location registration message including the first flow information to a local mobility anchor (LMA); and
receiving, by the first MAG from the LMA, a response message in response to the location registration message.

4. The method of claim 3, wherein the registering further comprises:
updating, by the LMA, a flow-based binding entry for the multi-mode terminal, based on the first flow information.

5. The method of claim 3, wherein the registering further comprises:
updating, by the first MAG, flow-based binding information, based on the response message.

6. The method of claim 1, wherein the first flow information comprises
first multi-mode terminal identification (ID) information that distinguishes the first multi-mode terminal from other different terminals.

7. The method of claim 1, wherein the first flow information comprises
the first flow ID of the first flow and characteristic information of the first flow.

8. The method of claim 7, wherein the characteristic information of the first flow comprises
configuration information of the first flow and a quality of service (QoS) of the first flow.

9. The method of claim 1, wherein the first flow information comprises
information associated with an interface to be used as a default among the plurality of physical network interfaces of the multi-mode terminal.

10. The method of claim 1, further comprising:
receiving, by a second MAG from the multi-mode terminal, second flow information associated with a second flow;
registering, by the second MAG, the second flow information associated with the second flow; and
transmitting, by the second MAG, data of the second flow to the multi-mode terminal,
wherein the second MAG is connected to the multi-mode terminal through a second physical network interface among the plurality of physical network interfaces of the multi-mode terminal.

11. The method of claim 1, further comprising:
transmitting, by the second MAG, the data of the first flow to the multi-mode terminal.

12. The method of claim 1, further comprising:
receiving, by the LMA, data from a correspondent node;
searching, by the LMA, for flow-based binding information associated with a second flow to which the data belongs, and determining an access network for the second flow based on a result of the search;
transmitting, by the LMA, the data to a second MAG corresponding to the access network; and
transmitting, by the second MAG, the data to the multi-mode terminal.

13. The method of claim 12, wherein the LMA searches for the flow-based binding information associated with the second flow to which the data belongs, and utilizes the flow-based binding information included in a binding entry associated with the second flow to which the data belongs when the binding entry exists, so as to determine the access network.

14. The method of claim 12, wherein the LMA searches for the flow-based binding information associated with the second flow to which the data belongs, and, when a binding entry associated with the second flow to which the data belongs fails to exist, utilizes policy information of the multi-mode terminal and the second flow information of the data so as to define the second flow to which the data belongs, and to determine the access network to service the second flow.

15. The method of claim 12, wherein the LMA searches for the flow-based binding information associated with the second flow to which the data belongs, and, when a binding entry associated with the second flow to which the data belongs fails to exist, utilizes default interface information of the multi-mode terminal so as to determine a default access network of the multi-mode terminal to be the access network.

16. A communication method of a multi-mode terminal, equipped with a plurality of physical interfaces, based on a flow mobility in a proxy mobile internet protocol version 6 (PMIPv6) based network, the method comprising:
triggering flow-based location registration by transmitting first flow information associated with a first flow forming a first service to a first mobile access gateway (MAG); and
receiving data of the first flow from the first MAG,
wherein the first MAG is connected to the multi-mode terminal through a first physical network interface among the plurality of physical network interfaces.

17. The method of claim 16, further comprising:
triggering flow-based location registration by transmitting second flow information associated with a second flow forming a second service to a second MAG; and
receiving data of the second flow from the second MAG,
wherein the second MAG is connected to the multi-mode terminal through a second physical network interface among the plurality of physical network interfaces.

18. The method of claim 16, further comprising:
receiving the data of the first flow from the second MAG;
monitoring the first flow, and assessing a suitability of an access network that services the first flow; and
searching for and determining an access network to service the first flow based on the assessment,
wherein the first MAG exists in the access network determined newly by the search.

19. A multi-mode terminal equipped with a plurality of physical network interfaces, the multi-mode terminal comprising:
a controller to generate first flow information associated with a first flow forming a first service and second flow information associated with a second flow forming a second service;
a first physical network interface to transmit the first flow information to a first mobile access gateway (MAG); and
a second physical network interface to transmit the second flow information to a second MAG.
